(19) United States
(12) Patent Application Publication
(10) Pub. No.: US 2005/0209096 A1
(43) Pub. Date: Sep. 22, 2005

(54) Supported polymerisation catalysts

(76) Inventors: Grant Berent Jacobsen, Bouc Bel Air (FR); Brian Stephen Kimberley, Bouche Du Rhone (FR); Sergio Mastroianni, Martigues (FR); Michael John Taylor, Sunbury on Thames (GB); Eliane Garcia, Martigues (FR); Gerard Lacane, Marignane (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/524,730

(22) PCT Filed: Aug. 14, 2003
(86) PCT No.: PCT/GB03/03565

§ 371 Date: Feb. 16, 2005

(30) Foreign Application Priority Data
Aug. 20, 2002 (EP) 02358018.6
Aug. 20, 2002 (EP) 02358019.4

(51) Int. Cl. B01J 31/00; C08F 4/44

(52) U.S. Cl. 502/152; 502/103; 502/117; 526/943; 526/126; 526/170; 526/129; 526/348.2; 526/348.5; 526/348.6

(57) ABSTRACT

A novel process for the preparation of a supported transition metal catalyst system said method comprises the steps of: (i) mixing together in a suitable solvent (a) an organometallic compound, and (b) an ionic activator comprising a cation and an anion, (ii) addition of the mixture from step (i) to a support material, and (iii) addition of a transition metal compound in a suitable solvent, characterised in that the molar ratio of organometallic compound (a) to ionic activator (b) in step (i) is in the range 0.1 to 2.0. By use of the reduced molar ratio of the organometallic compound to the ionic activator in step (i) better reproducibilty of the catalyst may be achieved as well as higher activities. In addition polymer properties may be improved for example higher melt strength resulting in better product performance. The preferred transition metal compounds are metallocenes.

The present invention relates to supported catalysts suitable for the polymerisation of olefins and in particular to supported metallocene catalysts providing advantages for operation in gas phase processes.

In recent years there have been many advances in the production of polyolefin homopolymers and copolymers due to the introduction of metallocene catalysts. Metallocene catalysts offer the advantage of generally a higher activity than traditional Ziegler catalysts and are usually described as catalysts which are single site in nature. There have been developed several different families of metallocene complexes. In earlier years catalysts based on bis(cyclopentadienyl) metal complexes were developed, examples of which may be found in EP 129368 or EP 206794. More recently complexes having a single or mono cyclopentadienyl ring have been developed. Such complexes have been referred to as ‘constrained geometry’ complexes and examples of these complexes may be found in EP 416815 or EP 420436. In both of these complexes the metal atom eg. zirconium is in the highest oxidation state.

Other complexes however have been developed in which the metal atom may be in a reduced oxidation state. Examples of both the bis(cyclopentadienyl) and mono (cyclopentadienyl) complexes have been described in WO 96/04290 and WO 95/00526 respectively.

The above metallocene complexes are utilised for pblymerisation in the presence of a cocatalyst or activator. Typically activators are aluminoxanes, in particular methyl aluminoxane or compounds based on boron compounds. Examples of the latter are borates such as trialkyl-substituted ammonium tetraphenyl- or tetrafluorophenyl-borates. Catalyst systems incorporating such borate activators are described in EP 561479, EP 418044 and EP 551277.

The above metallocene complexes may be used for the polymerisation of olefins in solution, slurry or gas phase. When used in the gas phase the metallocene complex and/or the activator are suitably supported. Typical supports include inorganic oxides eg. silica or polymeric supports may alternatively be used.

Examples of the preparation of supported metallocene catalysts for the polymerisation of olefins may be found in WO 94/26793, WO 95/07939, WO 96/00245, WO 96/04318, WO 97/02297 and EP 642536.

WO 98/27119 describes supported catalyst components comprising ionic compounds comprising a cation and an anion in which the anion contains at least one substituent comprising a moiety having an active hydrogen. In this disclosure supported metallocene catalysts are exemplified in which the catalyst is prepared by treating the aforementioned ionic compound with a trialkylaluminium compound followed by subsequent treatment with the support and the metallocene.

WO 98/27119 also describes a method for activating a substantially inactive catalyst precursor comprising (a) an ionic compound comprising a cation and an anion containing at least one substituent comprising a moiety having an active hydrogen, (b) a transition metal compound and optionally, (c) a support by treatment with an organometallic compound thereby forming an active catalyst.

Various methods have been utilised to prepare supported catalysts of this type. For example WO 98/27119 describes several methods of preparing the supported catalysts disclosed therein in which the support is impregnated with the ionic compound. The volume of the ionic compound may correspond from 20 volume percent to greater than 200 volume percent of the total pore volume of the support. In a preferred preparative route the volume of the solution of the ionic compound does not exceed substantially, and is preferably equal to, the total pore volume of the support. Such methods of preparation may be referred to as incipient precipitation or incipient wetness techniques.

More recently WO 02/06357 describes an improved incipient wetness technique for the preparation of a supported metallocene catalyst system in which the support is impregnated with an ionic compound and the metallocene complex followed by treatment with an organometallic compound.

We have now found an improvement in the incipient wetness technique which allows for reduced molar ratios of organometallic compound to the ionic compound resulting in better catalyst reproducibility and improved productivity in the gas phase as well as having economic benefits.

Thus according to the present invention there is provided a method for the preparation of a supported transition metal catalyst system said method comprising the steps of:
(i) mixing together in a suitable solvent
   (a) an organometallic compound, and
   (b) an ionic activator comprising a cation and an anion,
(ii) addition of the mixture from step (i) to a support material, and
(iii) addition of a transition metal compound in a suitable solvent,
characterised in that the molar ratio of organometallic compound (a) to ionic activator (b) in step (i) is in the range 0.1 to 2.0.

Suitable solvents for use in the present invention include lower alkanes eg isohexane or aromatic solvents eg—toluene.

The preferred molar ratio of organometallic compound (a) to ionic activator (b) is less than 1 and most preferably in the range 0.1 to 0.8 and preferably in the range 0.3 to 0.6.

The preferred metal with respect to the organometallic compound is aluminium and the preferred metal for the ionic activator is boron whereby the molar ratio of Al/B is in the range 0.1 to 2.0 and is preferably in the range 0.1 to 0.8. and most preferably in the range 0.3 to 0.6.

The ionic activators of the present invention typically comprise a cation and an anion and may be represented by the formula:
(L*-H)⁺_{d}(A^{d-})
wherein
L* is a neutral Lewis base
(L*-H)⁺_{d} is a Bronsted acid
A^{d-} is a non-coordinating compatible anion having a charge of d⁻, and
d is an integer from 1 to 3.

The cation of the ionic compound may be selected from the group consisting of acidic cations, carbonium cations, silylium cations, oxonium cations, organometallic cations and cationic oxidizing agents.

Suitably preferred cations include trihydrocarbyl substituted ammonium cations eg. triethylammonium, tripropylammonium, tri(n-butyl)ammonium and similar. Also suitable are N.N-dialkylanilinium cations such as N,N-dimethylanilinium cations.

The preferred ionic compounds used as activators are those wherein the cation of the ionic compound comprises a hydrocarbyl substituted ammonium salt and the anion comprises an aryl substituted borate.

Typical borates suitable as ionic compounds include:
triethylammonium tetraphenylborate
triethylammonium tetraphenylborate,
tripropylammonium tetraphenylborate,
tri(n-butyl)ammonium tetraphenylborate,
tri(t-butyl)ammonium tetraphenylborate,
N,N-dimethylanilinium tetraphenylborate,
N,N-diethylanilinium tetraphenylborate,
trimethylammonium tetrakis(pentafluorophenyl)borate,
triethylammonium tetrakis(pentafluorophenyl)borate,
tripropylammonium tetrakis(pentafluorophenyl)borate,
tri(n-butyl)ammonium tetrakis(pentafluorophenyl)borate,
N,N-dimethylanilinium tetrakis(pentafluorophenyl)borate,
N,N-diethylanilinium tetrakis(pentafluorophenyl)borate.

A preferred type of ionic activator suitable for use with the transition metal compounds of the present invention comprise ionic compounds comprising a cation and an anion wherein the anion has at least one substituent comprising a moiety having an active hydrogen.

Suitable activators of this type are described in WO 98/27119 the relevant portions of which are incorporated herein by reference.

Examples of this type of anion include:
triphenyl(hydroxyphenyl)borate
tri(p-tolyl)(hydroxyphenyl)borate
tris(pentafluorophenyl)(hydroxyphenyl)borate
tris(pentafluorophenyl)(4-hydroxyphenyl)borate

Examples of suitable cations for this type of cocatalyst include triethylammonium, triisopropylammonium, diethylmethylammonium, dibutylethylammonium and similar.

Particularly suitable are those cations having longer alkyl chains such as dihexyldecylmethylammonium, dioctadecylmethylammonium, ditetradecylmethylammonium, bis(hydrogenated tallow alkyl)methylammonium and similar.

Particular preferred activators of this type are alkylammonium tris(pentafluorophenyl) 4-(hydroxyphenyl)borates. A particularly preferred activator is bis(hydrogenated tallow alkyl)methyl ammonium tris(pentafluorophenyl) (4-hydroxyphenyl)borate.

With respect to this type of activator, a preferred compound is the reaction product of an alkylammonium tris(pentafluorophenyl)-4-(hydroxyphenyl)borate and an organometallic compound, for example triethylaluminium.

The organometallic compound utilised in step (i) is typically chosen from those containing a metal of Groups IA-IIIB of the Periodic Table but preferred organiometallic compounds are those of Group IIIB for example those containing aluminium.

Particularly preferred organometallic compounds are organoaluminium compounds for example trialkylaluminium compounds such as trimethylaluminium, triethylaluminium or triisobutylaluminium.

The use of triisobutylaluminium as organometallic compound has been found to lead to improved product properties in the resultant polymers, in particular improved melt strength may be achieved.

Suitable support materials include inorganic metal oxides or alternatively polymeric supports may be used.

The most preferred support material for use with the supported catalysts according to the process of the present invention is silica. Suitable silicas include Ineos ES70 and Grace-Davison 948 silicas.

The support material may be subjected to a heat treatment and/or chemical treatment to reduce the water content or the hydroxyl content of the support material. Typically chemical dehydration agents are reactive metal hydrides, aluminium alkyls and halides. Prior to its use the support material may be subjected to treatment at 100° C. to 1000° C. and preferably at 200 to 850° C. in an inert atmosphere under reduced pressure.

The support material may be further combined with an organometallic compound preferably an organoaluminium compound and most preferably a trialkylaluminium compound in a dilute solvent.

The support material is pretreated with the organometallic compound at a temperature of −20° C. to 150° C. and preferably at 20° C. to 100° C.

Alternative supports for the present invention are non-porous polystyrenes for example divinylbenzene crosslinked polystyrene.

Suitable transition metal compounds may be those based on the late transition metals (LTM) of Group VIII for example compounds containing iron, nickel, manganese, ruthenium, cobalt or palladium metals. Examples of such compounds are described in WO 98/27124 and WO 99/12981 and may be illustrated by [2,6-diacetylpyridinebis(2,6-diisopropylanil)FeCl₂], 2.6-diacetylpyridinebis(2,4,6-trimethylanil) FeCl₂ and [2,6-diacetylpyridinebis(2,6-diisopropylanil)CoCl₂].

Other catalysts include derivatives of Group IIIA, IVA or Lanthanide metals which are in the +2, +3 or +4 formal oxidation state. Preferred compounds include metal complexes containing from 1 to 3 anionic or neutral ligand groups which may be cyclic or non-cyclic delocalized π-bonded anionic ligand groups. Examples of such π-bonded anionic ligand groups are conjugated or non-conjugated, cyclic or non-cyclic dienyl groups, allyl groups, boratabenzene groups, phosphole and arene groups. By the term π-bonded is meant that the ligand group is bonded to the metal by a sharing of electrons from a partially delocalised π-bond.

Each atom in the delocalized π-bonded group may independently be substituted with a radical selected from the group consisting of hydrogen, halogen, hydrocarbyl, halohydrocarbyl, hydrocarbyl, substituted metalloid radicals wherein the metalloid is selected from Group IVB of the Periodic Table. Included in the term “hydrocarbyl” are C1-C20 straight, branched and cyclic alkyl radicals, C6-C20 aromatic radicals, etc. In addition two or more such radicals may together form a fused ring system or they may form a metallocycle with the metal.

Examples of suitable anionic, delocalised π-bonded groups include cyclopentadienyl, indenyl, fluorenyl, tetrahydroindenyl, tetrahydrofluorenyl, octahydrofluorenyl, etc. as well as phospholes and boratabenzene groups.

Phospholes are anionic ligands that are phosphorus containing analogues to the cyclopentadienyl groups. They are known in the art and described in WO 98/50392.

The boratabenzenes are anionic ligands that are boron containing analogues to benzene. They are known in the art and are described in Organometallics, 14, 1, 471-480 (1995).

The preferred polymerisation catalyst of the present invention is a bulky ligand compound also referred to as a metallocene complex containing at least one of the aforementioned delocalized π-bonded group, in particular cyclopentadienyl ligands. Such metallocene complexes are those based on Group IVA metals for example titanium, zirconium and hafnium.

Metallocene complexes may be represented by the general formula:
LxMQn
where L is a cyclopentadienyl ligand, M is a Group IVA metal, Q is a leaving group and x and n are dependent upon the oxidation state of the metal.

Typically the Group IVA metal is titanium, zirconium or hafnium, x is either 1 or 2 and typical leaving groups include halogen or hydrocarbyl. The cyclopentadienyl ligands may be substituted for example by alkyl or alkenyl groups or may comprise a fused ring system such as indenyl or fluorenyl.

Examples of suitable metallocene complexes are disclosed in EP 129368 and EP 206794. Such complexes may be unbridged eg. bis(cyclopentadienyl) zirconium dichloride, bis(pentamethyl)cyclopentadienyl dichloride, or may be bridged eg. ethylene bis(indenyl) zirconium dichloride or dimethylsilyl(indenyl) zirconium dichloride.

Other suitable bis(cyclopentadienyl) metallocene complexes are those bis(cyclopentadienyl) diene complexes described in WO 96/04290. Examples of such complexes are bis(cyclopentadienyl) zirconium (2.3-dimethyl-1,3-butadiene) and ethylene bis(indenyl) zirconium 1,4-diphenyl butadiene.

Examples of monocyclopentadienyl or substituted monocyclopentadienyl complexes suitable for use in the present invention are described in EP 416815, EP 418044, EP 420436 and EP 551277. Suitable complexes may be represented by the general formula:
CpMXₙ
wherein Cp is a single cyclopentadienyl or substituted cyclopentadienyl group optionally covalently bonded to M through a substituent, M is a Group VIA metal bound in a η⁵ bonding mode to the cyclopentadienyl or substituted cyclopentadienyl group, X each occurrence is hydride or a moiety selected from the group consisting of halo, alkyl, aryl, aryloxy, alkoxy, alkoxyalkyl, amidoalkyl, siloxyalkyl etc. having up to 20 non-hydrogen atoms and neutral Lewis base ligands having up to 20 non-hydrogen atoms or optionally one X together with Cp forms a metallocycle with M and n is dependent upon the valency of the metal.

Particularly preferred monocyclopentadienyl complexes have the formula: 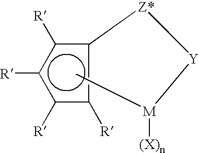
wherein:—
R′ each occurrence is independently selected from hydrogen, hydrocarbyl, silyl, germyl, halo, cyano, and combinations thereof, said R′ having up to 20 nonhydrogen atoms, and optionally, two R′ groups (where R′ is not hydrogen, halo or cyano) together form a divalent derivative thereof connected to adjacent positions of the cyclopentadienyl ring to form a fused ring structure;
X is hydride or a moiety selected from the group consisting of halo, alkyl, aryl, aryloxy, alkoxy, alkoxyalkyl, amidoalkyl, siloxyalkyl etc. having up to 20 non-hydrogen atoms and neutral Lewis base ligands having up to 20 non-hydrogen atoms,
   Y is —O—, —S—, —NR*—, —PR*—,
M is hafnium, titanium or zirconium,
Z* is SiR*₂, CR*₂, SiR*₂SIR*₂, CR*₂CR*₂, CR*═CR*, CR*₂SIR*₂, or GeR*₂, wherein:
R* each occurrence is independently hydrogen, or a member selected from hydrocarbyl, silyl, halogenated alkyl, halogenated aryl, and combinations thereof, said
R* having up to 10 non-hydrogen atoms, and optionally, two R* groups from Z* (when R* is not hydrogen), or an R* group from Z* and an R* group from Y form a ring system.,
and n is 1 or 2 depending on the valence of M.

Examples of suitable monocyclopentadienyl complexes are (tert-butylamido) dimethyl(tetramethyl-η⁵′ cyclopentadienyl) silanetitanium dichloride and (2-methoxyphenylamido)dimethyl(tetramethyl-η⁵-cyclopentadienyl) silanetitanium dichloride.

Other suitable monocyclopentadienyl complexes are those comprising phosphinimine ligands described in WO 99/40125, WO 00/05237, WO 00/05238 and WO00/32653. A typical example of such a complex is cyclopentadienyl titanium [tri (tertiary butyl)phosphinimine]dichloride.

Another type of polymerisation catalyst suitable for use in the present invention are monocyclopentadienyl complexes comprising heteroallyl moieties such as zirconium (cyclopentadienyl)tris(diethylcarbamates) as described in U.S. Pat. No. 5,527,752 and WO 99/61486.

Particularly preferred metallocene complexes for use in the preparation of the supported catalysts of the present invention may be represented by the general formula: 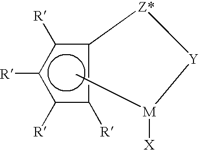
wherein:—
R′ each occurrence is independently selected from hydrogen, hydrocarbyl, silyl, germyl, halo, cyano, and combinations thereof, said R′ having up to 20 nonhydrogen atoms, and optionally, two R′ groups (where R′ is not hydrogen, halo or cyano) together form a divalent derivative thereof connected to adjacent positions of the cyclopentadienyl ring to form a fused ring structure;
X is a neutral η⁴ bonded diene group having up to 30 non-hydrogen atoms, which forms a π-complex with M;
Y is —O—, —S—, —NR*—, —PR*—,
M is titanium or zirconium in the +2 formal oxidation state;
Z* is SiR*₂, CR*₂, SiR*₂SIR*₂, CR*₂CR*₂, CR*═CR*, CR*₂SIR*₂, or GeR*₂, wherein:
R* each occurrence is independently hydrogen, or a member selected from hydrocarbyl, silyl, halogenated alkyl, halogenated aryl, and combinations thereof, said
R* having up to 10 non-hydrogen atoms, and optionally, two R* groups from Z* (when R* is not hydrogen), or an R* group from Z* and an R* group from Y form a ring system.

Examples of suitable X groups include s-trans-η⁴-1,4-diphenyl-1,3-butadiene, s-trans-η⁴-3-methyl-1,3-pentadiene; s-trans-η⁴-2,4-hexadiene; s-trans-n⁴-1,3-pentadiene; s-trans-η⁴-1,4-ditolyl-1,3-butadiene; s-trans-η⁴-1,4-bis(trimethylsilyl)-1,3-butadiene; s-cis-η⁴-3-methyl-1,3-pentadiene; s-cis-η⁴-1,4-dibenzyl-1,3-butadiene; s-cis-η⁴-1,3-pentadiene; s-cis-η⁴-1,4-bis(trimethylsilyl)-1,3-butadiene, said s-cis diene group forming a π-complex as defined herein with the metal.

Most preferably R′ is hydrogen, methyl, ethyl, propyl, butyl, pentyl, hexyl, benzyl, or phenyl or 2 R′ groups (except hydrogen) are linked together, the entire C₅R′₄ group thereby being, for example, an indenyl, tetrahydroindenyl, fluorenyl, tetrahydrofluorenyl, or octahydrofluorenyl group.

Highly preferred Y groups are nitrogen or phosphorus containing groups containing a group corresponding to the formula —N(R″)— or —P(R″)— wherein R″ is C₁₋₁₀ hydrocarbyl.

Most preferred complexes are amidosilane- or amidoalkanediyl complexes.

Most preferred complexes are those wherein M is titanium.

Specific complexes suitable for use in the preparation of the supported catalysts of the present invention are those disclosed in WO 95/00526 and are incorporated herein by reference.

A particularly preferred complex for use in the preparation of the supported catalysts of the present invention is (t-butylamido) (tetramethyl-η⁵-cyclopentadienyl)dimethyl silanetitanium-η⁴-1.3-pentadiene.

The molar ratio of transition metal compound to ionic activator employed in the method of the present invention may be in the range 1:10000 to 100:1. A preferred range is from 1:5000 to 10:1 and most preferred from 1:10 to 10:1.

It is advantageous in the present invention that the ionic activator is dried before contact with the organometallic compound. This enables lower ratios of organometallic compound to activator to be used without any detrimental effects on activity.

The supported transition metal catalysts of the present invention may be suitable for the polymerisation of olefin monomers selected from (a) ethylene, (b) propylene (c) mixtures of ethylene and propylene and (d) mixtures of (a), (b) or (c) with one or more other alpha-olefins.

Thus according to another aspect of the present invention there is provided a process for the polymerisation of olefin monomers selected from (a) ethylene, (b) propylene (c) mixtures of ethylene and propylene and (d) mixtures of (a), (b) or (c) with one or more other alpha-olefins, said process performed in the presence of a supported transition metal catalyst system as hereinbefore described.

The supported transition metal catalysts of the present invention may be used for the polymerisation of olefins in solution, slurry or the gas phase.

A slurry process typically uses an inert hydrocarbon diluent and temperatures from about 0° C. up to a temperature just below the temperature at which the resulting polymer becomes substantially soluble in the inert polymerisation medium. Suitable diluents include toluene or alkanes such as hexanei propane or isobutane. Preferred temperatures are from about 30° C. up to about 200° C. but preferably from about 60° C. to 100° C. Loop reactors are widely used in slurry polymerisation processes.

The preferred process for the present invention is the gas phase.

Suitable gas phase processes of the present invention include the polymerisation of olefins, especially for the homopolymerisation and the copolymerisation of ethylene and α-olefins for example 1-butene, 1-hexene, 4-methyl-1-pentene are well known in the art. Particularly preferred gas phase processes are those operating in a fluidised bed. Examples of such processes are described in EP 89691 and EP 699213 the latter being a particularly preferred process for use with the supported catalysts of the present invention.

Particularly preferred polymerisation processes are those comprising the polymerisation of ethylene or the copolymerisation of ethylene and α-olefins having from 3 to 10 carbon atoms.

Thus according to another aspect of the present invention there is provided a process for the pplymerisation of ethylene or the copolymerisation of ethylene and α-olefins having from 3 to 10 carbon atoms, said process performed under polymerisation conditions in the present of a supported transition metal catalyst system prepared as hereinbefore described.

By use of the reduced molar ratio of the organometallic compound to the ionic activator in step (i) better reproducibility of the catalyst may be achieved as well as higher activities. In addition polymer properties may be improved for example higher melt strength resulting in better product performance.

The present invention also allows for a more efficient procedure by preparing the supported transition metal catalyst in a one-pot procedure.

By one-pot is meant a preparation carried out without the need for washing steps after the formation of the final catalyst composition and typically wherein the contact between the support material, ionic activator and transition metal compound is performed in a single reaction vessel.

Thus according to another aspect of the present invention there is provided a method for the preparation of a supported transition metal catalyst system said method comprising the steps of:
(i) mixing together in a suitable solvent
   (a) an organometallic compound, and
   (b) an ionic activator comprising a cation and an anion,
(ii) addition of the mixture from step (i) to a support material, and
(iii) addition of a transition metal compound in a suitable solvent characterised in that the molar ratio of organometallic compound (a) to ionic activator (b) in step (i) is in the range 0.1 to 2.0 and wherein after step (iii) there are no washing steps performed before the solvent is removed.

The present invention will now be further illustrated with reference to the following examples:

Abbreviations

TEA triethylaluminium
TiBA triisobutylaluminium
Ionic Activator A [N(H)Me(C₁₈₋₂₂H₃₇₋₄₅)₂][(C₆F₅)₃(C₆H₄OH)]
Complex A (C₅Me₄SiMe₂N^{t}Bu)Ti(η⁴-1,3-pentadiene)

### EXAMPLE 1

Passivation of Silica

To a suspension of 60 g of silica (Grace-Davison 948), previously calcined at 250° C. for 5 hours under nitrogen, in 600 ml of hexane was added 122.5 ml of a hexane solution of triethylaluminium (TEA) (0.98 mol/l). After two hours at 30° C. the liquid phase was decanted and then silica was washed 5 times with 500 ml of hexane and then dried at 60° C. under vacuum. The aluminium content was 1.44 mmol/g support.

Drying of the Ionic Activator A Solution

A solution of the ionic activator A in toluene (10.66% wt) was dried by prolonged contact (1 week) with molecular sieve-4A (25% wt/wt) which had previously been dried at 250° C. for 2 days and cooled to ambient temperature under nitrogen atmosphere.

Catalyst Preparation

1.54 ml of the above solution of the dried ionic activator A was reacted with 0.25 ml TEA in toluene (0.25 mol/l) (molar ratio Al/B=0.5). 4 g of the passivated silica was slowly impregnated (15 min) with this solution and manually agitated until no lumps were visible followed by 30 min holding. 0.70 ml of a solution of the Complex A in heptane (9.17% wt) was then slowly added (15 min) and manually agitated until no lumps were visible followed by 30 min holding. 11 ml of TEA solution in hexane (5 mmol/l) was then added and the suspension was stirred for 15 minutes. The resultant catalyst was washed 3 times with 35 ml of hexane and then dried under vacuum to give a loading of [Ti]=29 μmol/g; [Al]=1.33 mmol/g.

Polymerisation Data

The catalyst from Example 1 was tested for ethylene-1-hexene copolymerisation as follows:

A 2.5 l double jacketed thermostatic stainless steel autoclave was purged with nitrogen at 70° C. for at least one hour. 400 g of PE pellets previously dried under vacuum at 80° C. for 12 hours were introduced and the reactor was then purged three times with nitrogen (7 bar to atmospheric pressure). 0.13 g of TEA treated silica (1.5 mmol TEA/g) was added under pressure and allowed to scavenge impurities for at least 15 minutes under agitation. The gas phase was then composed (addition of ethylene, 1-hexene and hydrogen) and a mixture of supported catalyst (˜0.1 g) and silica/TEA (˜0.1 g) was injected. A constant pressure of ethylene and a constant pressure ratio of ethylene/co-monomer were maintained during the run. After 1 hour the run was terminated by venting the reactor and then purging the reactor 3 times with nitrogen. The PE powder produced during the run was then separated from the PE seed bed by simple sieving. Typical conditions were as follows:
Temperature: 70° C.
Ethylene pressure: 6.5 b
P(1-hexene)/P(ethylene): 0.004-0.008
Hydrogen: 70-100 ml added during the gas phase composition

The activity of the catalyst was 105 g/ghbar and the polymer produced had a density of 0.918 g/ml and a MI (2.16) of 0.75 g/10 min.

### EXAMPLE 2

Passivation of Silica

To a suspension of 20 g of silica (Grace-Davison 948), previously calcined at 250° C. for 5 hours under nitrogen, in 100 ml of hexanes was carefully added 42 ml of a hexane solution of triisobutylaluminium (TiBA) (0.952 mol/l) over 20 minutes. After two hours at 30° C. the liquid phase was decanted and the silica was washed 5 times with 500 ml of hexanes and then dried at 60° C. under vacuum. The aluminium content was 1.05 mmol/g support.

Drying of the Ionic Activator A Solution

A solution of the ionic activator A in toluene (10.66% wt) was dried by prolonged contact (1 week) with molecular sieve-4A (25% wt/wt), which had previously been dried at 250° C. for 2 days and cooled to ambient temperature under nitrogen atmosphere.

Catalyst Preparation

1.16 ml of the above dried ionic activator solution A was reacted with 0.19 ml TiBA solution in toluene (0.25 mol/l) (molar ratio Al/B=0.5). 3 g of the passivated silica was slowly impregnated (15 min) with this solution and manually agitated until no lumps were visible followed by 30 min holding. 0.53 ml of a solution of the Complex A in heptane (9.17% wt) was then slowly added (15 min) and manually agitated until no lumps were visible, followed by 30 min holding. 8.09 ml of TEA solution in hexanes (5 mmol/l) was the added and the suspension was stirred for 15 minutes. The catalyst was washed 3 times with 25 ml of hexane then dried under vacuum to give a loading of [Ti]=21 μmol/g of catalyst; [Al]=1.1 mmol/g.

Polymerisation Data

The catalyst was tested for polymerisation activity in a manner identical to that described in Example 1. The activity was 66 g/ghbar (3160 g/mmolhb) and the polymer produced had a density of 0.9195 g/ml a MI (2.16) of 1.05 g/10 min a MI (21.6) of 24.5 g/10 min a MFR of 23.3 and a melt strength at 16 Mpa of 5.54 cN.

δ(MS)/δ(P)=0.278 cN/Mpa.

### EXAMPLE 3

### One-Pot Procedure

To 3 g. Ineos ES70 silica (previously calcined at 500° C. for 5 hours under nitrogen, pore volume 1.55 mg/g) was added a solution made with 2.79 ml of a hexane solution of triisobutylaluminium (TiBA), 1 mol/l and 1.86 ml of hexane. The mixture was allowed to react for 2.5 hours under agitation then dried under vacuum.

2 ml solution of ionic activator A (previously dried by prolonged contact with molecular sieves 4A) was reacted with 0.307 ml TiBA solution in toluene (0.265 mol/l) (molar ratio Al/B=0.5). 1.57 ml of the resultant solution was slowly impregnated over 15 mins. to the above TiBA treated silica and manually agitated until no lumps were visible. The solution was left for 30 min.

0.716 ml of a solution of Complex A in heptane (9.17% wt) was then slowly added over 15 min. and the resultant solution manually agitated until no lumps were visible. The solution was then left for 60 min followed by addition of 20 ml hexane.

The resultant suspension was agitated for 10 min. then the solid phase allowed to decant and the liquid phase removed. The catalyst was then dried under vacuum to give a loading of [Ti]=40 μmol/g of catalyst and [Al]=0.83 mmol/g catalyst.

Polymerisation Data

The catalyst was tested for polymerisation activity in a manner identical to that described in Example 1 and the activity was found to be 74 g/ghbar

1. A method for the preparation of a supported transition metal catalyst system said method comprising the steps of:
(i) mixing together in a suitable solvent
(a) an organometallic compound, and
(b) an ionic activator comprising a cation and an anion,
(ii) adding the mixture from step (i) to a support material, and
(iii) adding a transition metal compound in a suitable solvent, wherein the molar ratio of organometallic compound (a) to ionic activator (b) in step (i) is in the range of from 0.1 to 2.0.

2. A method according to claim 1 wherein the molar ratio of organometallic compound (a) to ionic activator (b) is in the range of from 0.3 to 0.6.

3. A method according to claim 1 or 2 wherein the organometallic compound comprises a Group IIIB metal.

4. A method according to claim 3 wherein the organometallic compound is an organoaluminium compound.

5. A method according to claim 4 wherein the organoaluminium compound is triisobutylaluminium.

6. A method according to claim 1 wherein the ionic activator has the formula:
(L*-H)⁺_{d}(A^{d-})
wherein
L* is a neutral Lewis base
(L*-H)⁺_{d} is a Bronsted acid
A^{d-} is a non-corodinating compatible anion having a charge of d⁻, and d is an integer from 1 to 3.

7. A method according to claim 6 wherein the ionic activator comprises a cation and an anion wherein the anion has at least one substituent comprising a moiety having an active hydrogen.

8. A method according to claim 1 wherein the transition metal compound is a metallocene.

9. A method according to claim 8 wherein the metallocene has the formula:
CpMXₙ
wherein Cp is a single cyclopentadienyl or substituted cyclopentadienyl group optionally covalently bonded to M through a substituent, M is a Group VIA metal bound in a η⁵ bonding mode to the cyclopentadienyl or substituted cyclopentadienyl group, X each occurrence is hydride or a moiety selected from the group consisting of halo, alkyl, aryl, aryloxy, alkoxy, alkoxyalkyl, amidoalkyl, and siloxyalkyl having up to 20 non-hydrogen atoms and neutral Lewis base ligands having up to 20 non-hydrogen atoms or optionally one X together with Cp forms a metallocycle with M and n is dependent upon the valency of the metal.

10. A method according to claim 8 wherein the metallocene is represented by the general formula: 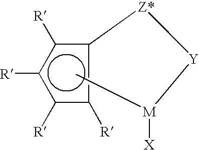
wherein:—
R′ each occurrence is independently selected from the group consisting of hydrogen, hydrocarbyl, silyl, germyl, halo, cyano, and combinations thereof, said R′ having up to 20 nonhydrogen atoms, and optionally, two R′ groups (where R′ is not hydrogen, halo or cyano) together form a divalent derivative thereof connected to adjacent positions of the cyclopentadienyl ring to form a fused ring structure;
X is a neutral η⁴ bonded diene group having up to 30 non-hydrogen atoms, which forms a π-complex with M;
Y is —O—, —S—, —NR*—, —PR*—,
M is titanium or zirconium in the +2 formal oxidation state;
Z* is SiR*₂, CR*₂, SiR*₂SIR*₂, CR*₂CR*₂, CR*═CR*, CR*₂SIR*₂, or GeR*₂, wherein:
R* each occurrence is independently hydrogen, or a member selected from the group consisting of hydrocarbyl, silyl, halogenated alkyl, halogenated aryl, and combinations thereof, said
R* having up to 10 non-hydrogen atoms, and optionally, two R* groups from Z* (when R* is not hydrogen), or an R* group from Z* and an R* group from Y form a ring system.

11. A method according to claim 1 wherein the support material is silica.

12. A method according to claim 11 wherein the silica is pretreated with an organometallic compound.

13. A method for the preparation of a supported transition metal catalyst system said method comprising the steps of:
(i) mixing together in a suitable solvent
(a) an organometallic compound, and
(b) an ionic activator comprising a cation and an anion,
(ii) adding the mixture from step (i) to a support material, and
(iii) adding a transition metal compound in a suitable solvent wherein the molar ratio of organometallic compound (a) to ionic activator (b) in step (1) is in the range of from 0.1 to 2.0 and wherein after step (iii) there are no washing steps performed before the solvent is removed.

14. A process for the polymerisation of olefin monomers selected from (a) ethylene, (b) propylene (c) mixtures of ethylene and propylene and (d) mixtures of (a), (b) or (c) with one or more other alpha-olefins, said process performed in the presence of a supported transition metal catalyst system prepared according to the method of claim 1 or 13.

15. A process for the polymerisabon of ethylene or the copolymerisation of ethylene and α-olefins having from 3 to 10 carbon atoms, said process performed under polymerisation conditions in the presence of a supported catalyst system prepared according to the method of claim 1 or 13.

16. A process according to claim 15 wherein the α-olefin is 1-butene, 1-hexene, 4-methyl-1-pentene or 1-octene.

17. A process according to claim 14 performed in the solution, slurry or gas phase.

18. A process according to claim 14 performed in a fluidized bed gas phase reactor.
